(19) United States
(12) Patent Application Publication
(10) Pub. No.: US 2004/0108615 A1
(43) Pub. Date: Jun. 10, 2004

(54) Durable water-dispersible foam

(76) Inventor: Daphne Gayle Foley, Chandler, AZ (US)

Correspondence Address: Daphne Gayle Foley, 615 N. Sun Meadows Ave, Chandler, AZ, 85226, US

(21) Appl. No.: 10/315,898

(22) Filed: Dec. 9, 2002

(51) Int. Cl. B29C 44/12

(52) U.S. Cl. 264/46.4; 264/233; 264/46.5; 264/255

(57) ABSTRACT

This disclosure covers methods of use and manufacture, and apparatuses for dispensing, and compositions of durable, water-dispersible or water-soluble polymer foams.

Durable water-dispersible foam is soluble in aqueous solutions after curing, does not collapse into a film when dry after curing, and does not require hot extrusion in order to form foam. Durable water-dispersible foams may contain additives and fillers.

Durable water-dispersible foams may be applied directly to objects before, during, and/or after curing. For example, durable water-dispersible foams may be sprayed directly onto plants, fruits, vegetables, and other water-resistant objects in order to provide temporary insulation, or for protection during shipping and handling. When the durable water-dispersible foam is no longer needed, it is simply rinsed away with water. Durable water-dispersible foam may also be used as a seed-sowing medium, fire fighting foam, erosion control, modeling material, mold-making material, molded material, and as a frost-protection barrier for plants.

### TECHNICAL FIELD

The present invention pertains to compositions, methods of manufacture, and methods of use of durable water-dispersible polymer foam as well as apparatuses and methods for storing and dispensing durable water-dispersible foam.

### BACKGROUND OF THE INVENTION

Durable, rigid polymer foams are well known in the art, and are commonly used for insulation, packaging, and cushioning. Conventional durable polymer foams do not spontaneously collapse after curing and are not water-dispersible. Forcing gas into a mixture of water and surfactants generates aqueous foams, which typically collapse down to a film within hours. Starch and cellulose-based foams are water-dispersible, but must be boiled or steamed in order to form durable foam, which places severe limitations on the ways in which starch-based foams may be used. Durable biodegradable polymer foams have been developed, but they take time, bacteria, and/or sunlight to degrade.

Water-dispersible polymer compositions are known to the art, such as the polyurethane formulations disclosed in U.S. Pat. No. 6,365,697 (Kim, et al, Apr. 2, 2002, herein incorporated by reference) and U.S. Pat. No. 6,262,176 (Kim, et al, Jul. 17, 2001, herein incorporated by reference). Neither of the Kim patents suggests or discloses any use for water-dispersible polymers in foam form. Conventional water-dispersible polymer preparations are not known to be used as durable foams.

Various blowing agents are used in conventional polymer foams. The use of CO2 as a blowing agent for a single-component aerosol conventional, water-insoluble polyurethane foam is disclosed in U.S. Pat. No. 6,013,691 (Braun et al, Jan. 11, 2000, herein incorporated by reference.)

None of the foregoing materials permits a rigid, durable, contour-following insulator to be applied directly to an object and then be easily removed. Durable water-dispersible foam materials have not been described or suggested in the literature.

### SUMMARY OF THE INVENTION

This disclosure covers methods of manufacture, methods of use, apparatuses for dispensing, and compositions of durable water-dispersible polymer foams.

Durable water-dispersible foam lasts indefinitely until washed away, is soluble in aqueous solutions after curing, does not collapse into a film when dry after curing, and does not require hot extrusion in order to form foam. Durable water-dispersible foams may contain additives and fillers to adapt the foam to a particular purpose.

Durable water-dispersible foams may be applied directly to objects before, during, and after curing. For example, durable water-dispersible foams may be sprayed directly onto plants, fruits, vegetables, and other water-resistant objects in order to provide temporary insulation, or for protection during shipping and handling. The foam clings where it is applied and cures in place. When the durable water-dispersible foam is no longer needed, it may be simply rinsed away with water. Durable water-dispersible foam may also be used as a seed-sowing medium, for erosion control, as a modeling material, as a mold-making material, as a molded material, as fire-fighting foam, and as a frost-protection barrier for plants.

The term “water-dispersible” is used in the art to describe both water-soluble prepolymers that polymerize into insoluble plastics, and polymers that are water-soluble after polymerization or curing. In this application, “water-dispersible” refers only to polymers that are water-soluble after polymerization or curing.

Durable water-dispersible foams fill a long-felt, unmet need for an insulator and packaging material that can be applied directly to objects in situ and conforms perfectly to very complex shapes while still being easy to remove. For example, durable water-dispersible foam may be sprayed to rigidly cover a cactus or glass object during shipment and may be easily washed away with water after use, a task that is impossible for conventional polymer spray foams. Because durable water-dispersible foam lasts indefinitely unless dissolved, it can protect a crop from freezing for several days, a task that aqueous crop spraying foams cannot do. Durable water-dispersible foam may be used to create water-disposable food containers using conventional polymer foam processing equipment, unlike the specialized high-temperature and pressure equipment needed to manufacture foamed starch articles. Unlike starch-foam packing peanuts, durable water-dispersible foams can conform more exactly to the shape of an object and immobilize an object in a container. Despite the unique properties, uses, and advantages of durable water-dispersible foams, the prior art teaches against and suggests no uses for durable water-dispersible foams. This suggests that the compositions and uses of durable water-dispersible foams are not obvious to those of ordinary skill in the art, even in the arts of packaging and environmentally friendly polymers.

The use of conventional water-dispersible plastics in the form of a foam is novel and has not been found in the literature. Durable water-dispersible foams are novel and have not been found in the literature.

### BRIEF DESCRIPTION OF THE SEVERAL VIEWS OF THE DRAWING

FIG. 1A illustrates a cross-sectional view of plant seedlings encased in durable water-dispersible foam.

FIG. 1B illustrates a cross-sectional view of an orchid partially encased in durable water-dispersible foam.

FIG. 1C illustrates a cross-sectional view of a cactus partially encased in durable water-dispersible foam.

FIG. 2 illustrates a cross-sectional view of a person spraying durable water-dispersible foam onto a saguaro cactus and associated support structure.

FIG. 3 illustrates a cross sectional view of a block of apples encased in durable water-dispersible foam.

FIG. 4 illustrates a cross-sectional view of a glass condenser encased in and filled with durable water-dispersible foam.

FIG. 5 illustrates a cross-sectional view of a row of lettuce being encased in durable water-dispersible foam to protect the lettuce from freezing.

FIG. 6 illustrates durable water-dispersible foam being used to disperse and protect seeds in a burned-out forest area.

FIG. 7 illustrates a cross sectional view of a roll of durable water-dispersible foam being laid down to control wind erosion.

FIG. 8 illustrates durable water-dispersible fire retardant foam being used to protect a house and extinguish flames in trees.

FIG. 9A is a block diagram of the steps of using durable water-dispersible foam to protect a saguaro cactus during transplanting.

FIG. 9B is a block diagram of the steps of using durable water-dispersible fire retardant foam to protect a house from a nearby forest fire.

FIG. 10 is a block diagram of the steps of manufacturing durable water-dispersible foam.

### DETAILED DESCRIPTION OF EMBODIMENTS OF THE INVENTION

### General Properties of the Invention

Parameters

Durable water-dispersible foams are durable polymer foams that chemically break down and/or dissolve in aqueous solutions. A foam may be a two phase system comprising gas bubbles surrounded by liquid and/or solid thin films. Durable foam is foam that does not spontaneously collapse when dry after curing. The aqueous solution may be rain, ground water, sea water, waste water, tap-water, other treated water, or water to which chemicals have been added to enhance the solubility of the durable water-dispersible foam. Durable water-dispersible foam may dissolve in a constant spray of aqueous solution within a few seconds to 1 week per cubic foot. Durable water-dispersible foams may have Indentation Force Deflection values between approximately 1 and 100 pounds/square inch, when tested according to ASTM D3574. The durable water-dispersible foam herein described does not require boiling or scalding water temperatures in order to form, unlike starch-based foams.

Durable water-dispersible foams of various curing times, densities, moduli of elasticity, solubilities, and compression strengths may be formulated by those skilled in the art of polymer chemistry. For example, a durable water-dispersible foam may be formulated which cures in one minute to a density of 0.5 lbs/ft\hat{ }3 and a 10% compression strength of 1 psi, which is elastic, and which will dissolve in seconds in water. Such a formulation may be particularly suitable for insulating crops against freezing temperatures. In an alternative example, a durable water-dispersible foam may be formulated which cures in one hour to a density of 10 lbs/ft\hat{ }3 and a 10% compression strength of 100 psi, which is rigid, and which dissolves in several minutes when sprayed with water. Such a formulation may be particularly suitable for encasing a large cactus, such as a saguaro or ocotillo, prior to transplanting. Durable water-dispersible foams may be formulated which have various expansion rates during curing.

Polymer foams, particularly polyurethane foams, are conventionally dispensed either as one component with a blowing agent or as multiple components, in separate containers, which are combined as the foam is dispensed. Durable water-dispersible foams may likewise be formulated to be dispensed as one component or multiple component systems. A single component durable water-dispersible foam may be dispensed by releasing the pressurized polymer, solvent, and/or blowing agent from its pressurized container, for example, by spraying the durable water-dispersible foam from an aerosol can. Durable water-dispersible foam formulations may include constituents such as prepolymers, polymers, catalysts, solvents, blowing agents, additives, and fillers.

Durable water-dispersible polymer foams may be dispensed by spraying from pressurized cans or foam-blowing guns, or by extruding, or by pouring, or by mixing, or by injecting, and/or by other conventional means and apparatus. Durable water-dispersible foams typically expand after they are dispensed, are soft and somewhat fluidic before curing, and cure into durable foam with a set shape. Durable water-dispersible foam may be dispensed free form or it may be applied directly to objects. Durable water-dispersible foam may be applied to objects before, during, and after curing. Cured durable water-dispersible foams may be in the form of sheets, molded articles, blocks, pellets, ropes, coatings, or other simple or complex shapes.

Durable water-dispersible foam may be shaped before or after curing. Durable water-dispersible foam may be shaped by sculpting, modeling, carving, molding, extruding, spraying, stamping, cutting, impressing, expressing, compressing, and/or handling. For example, a cured block of durable water dispersible foam may be carved or cut into various shapes. Sheets of cured durable water-dispersible foam may be stamped into flat shapes or compressed into flat sheets. Uncured durable water-dispersible foam may be sprayed onto surfaces, or extruded in the form of strands or tubes. Uncured durable water-dispersible foam may be expressed from a tube. Uncured durable water-dispersible foam may be sculpted by handling the foam with the hands or tools. Durable water-dispersible foams may be modeled or molded into desired shapes, for example, solid foam inserts for shipping electronics. Durable water-dispersible foams may be impressed with stamped shapes.

Polymer Materials

A polymer foam is a foam generated substantially from film-forming polymers or plastics, for example: polyurethane, polyethylene, polyether, polypropylene, acrylic, rubber, epoxy, and/or polyvinyl alcohol and their derivatives. Chemical reactions may take place during the formation of polymer foams, resulting in crosslinked polymer chains. Durable water-dispersible foams may be made by formulating the polymer with the proper hydrophilic and/or hydrolytic additives in the polymer backbone and/or polymer ends. Durable water-dispersible foams derived from polyurethane are preferred, but this invention is not limited to polyurethane foam derivatives.

It is desirable that the polymers used, in addition to being water-dispersible, also be biodegradable and minimally toxic, particularly after being washed away after use. For applications involving live plants or food storage, the durable water-dispersible foam composition should not be acutely toxic or otherwise damaging to the plant or food item; in particular, a durable water-dispersible foam that may be dispensed and cured at a non-damaging low temperature is suggested.

Blowing Agents

Any conventional blowing agent may be used, for example, hydrocarbons and compressed gasses. In particular, carbon dioxide, nitrogen, water, and air blowing agents are particularly suitable for this invention because they are non-toxic to plants and non-damaging to most other substrates and the environment. Water may be used as a blowing agent for durable water-dispersible foam where the formulation of the durable water-dispersible foam prevents the blowing water from collapsing the cured foam. For example, water may be included in a formulation to provide water of hydration for mineral fillers or as a reactant in the curing process of the durable water-dispersible polymer or other filler polymers.

Additives

Durable water-dispersible foams may contain conventional or novel additives and fillers. Some examples of additives and fillers which may be incorporated into a durable water dispersible foam are: catalysts, colorants, desiccants, minerals, chemicals, starches, cellulose, sugars, dyes, flame retardants, foaming agents, foam modifiers, softeners, plasticizers, UV stabilizers, antifungal agents, insecticidal agents, antibacterial agents, seeds, seed-germinating agents, insecticides, antifreeze, fertilizers, nitrogen-fixing bacteria, microorganisms, preservatives, release agents, water-insoluble polymers, antiperspirant, water, and innoculants.

Coatings

In order to protect the durable water-dispersible foam from accidental dissolution during shipment or other use, a coating may be applied to the surface of the cured durable water-dispersible foam. For example, a block of durable water-dispersible foam may be shrink-wrapped in plastic or coated with waterproof lacquer to prevent premature contact with water. Uncured durable water-dispersible foam may also be injected into watertight containers. The coating may be removed or compromised before the block is rinsed away.

### Applications

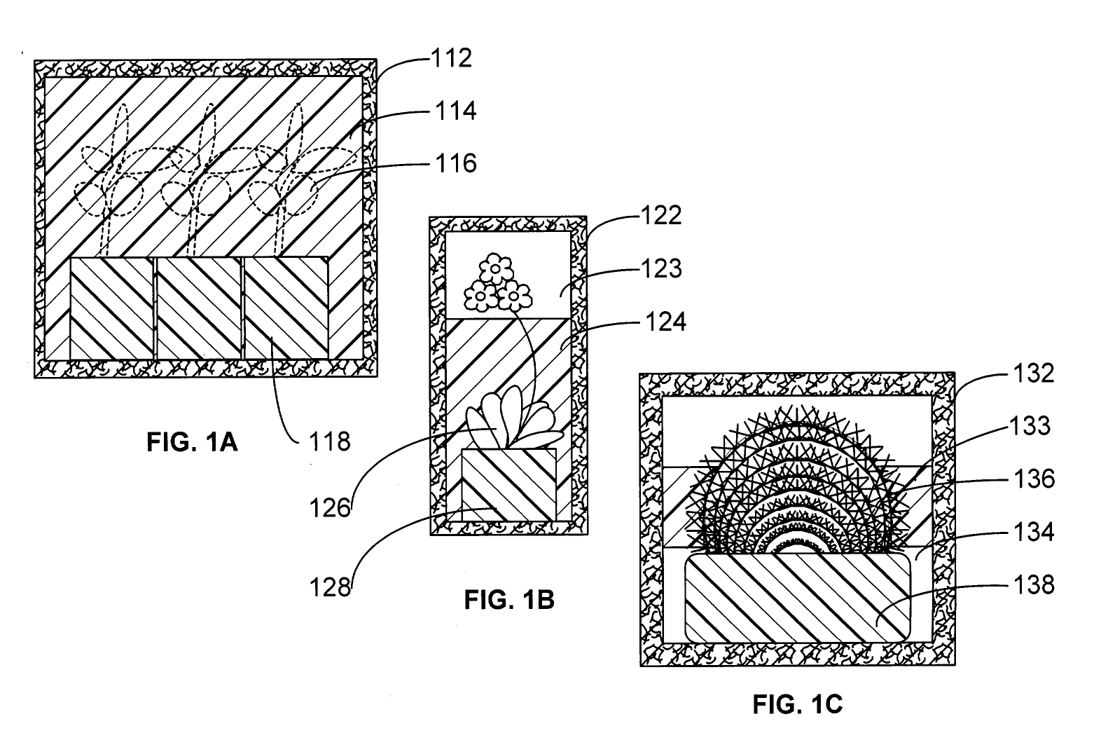

FIGS. 1A, 1B, and 1C show embodiments of the invention used in the shipment of live plants and seedlings. Conventionally, plants are shipped either bare-root in plastic bags in boxes or planted in pots and fixed into shipping cartons. Potted plants are conventionally held stable in a shipping carton by means of cardboard or plastic inserts that fix the pot to the shipping carton and provide minimal support to the leafy part of the plant. According to this invention, potted or bare-root plants may be completely encapsulated in durable water-dispersible foam in the shipping carton, shipped, and unpacked by spraying water on the durable water-dispersible foam. The shipped plants are protected from impacts and temperature changes during shipment.

FIG. 1A illustrates an embodiment of the invention wherein seedlings 116 in pots 118 are completely encapsulated within durable water-dispersible foam 114 in cardboard box 112. This provides complete, contour-following structural support and immobilization. This embodiment is recommended for short-term use, such as overnight shipping.

FIG. 1B illustrates an embodiment of the invention wherein orchid 126 in pot 128 is partially encased in durable water-dispersible foam 124 in box 122, with airspace 123 left free. This novel use of the novel foam permits the orchid flower stalk to be completely supported and immobilized for shipment without impeding the further blooming of orchid 126.

FIG. 1C illustrates an embodiment of the invention wherein a cactus 136 in pot 138 is placed in box 132, then immobilized in box 132 with a band of foamed-in-place durable water-dispersible foam 133. Air space 134 permits cactus 136 to respirate so that it may remain embedded in the durable water-dispersible foam for extended periods of time. This combination of shape-adaptiveness, light weight, rigid immobilization, and easy removal is unique to durable water-dispersible foam.

Durable water-dispersible foam formulated for shipping living plants may also contain antifungal agents, insecticides, and/or fertilizers. Durable water-dispersible foam formulated with a carbon dioxide or air blowing agent may supply carbon dioxide to the plant during shipment. It is possible that the plant will respirate a small amount of water through its leaves during shipment, and dissolve a thin layer of open space around itself. It is desirable that a plant to be encapsulated for shipment have dry leaves. A moisture barrier, such as a piece of cardboard or plastic, between the soil and the durable water-dispersible foam may be useful. Depending on the needs and structure of the plant, the entire plant and its pot may be encapsulated in durable water-dispersible foam or part of the plant may be left exposed to the air for respiration, while still providing excellent shipping properties.

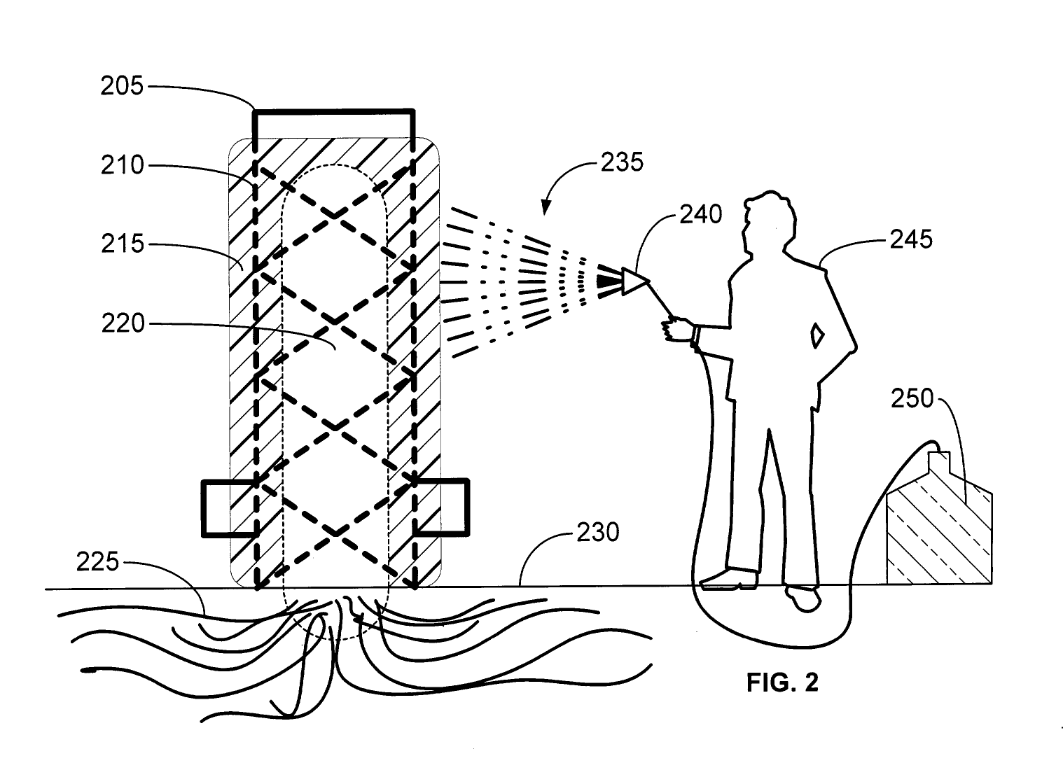

FIG. 2 illustrates an alternate embodiment, wherein a plant to be transplanted may be covered with a plant-friendly durable water-dispersible foam in situ without being in a box. This is particularly useful when transplanting delicate plants or cacti. For example, a large saguaro cactus 220 may be thickly coated with a strong, dense, air-blown durable water-dispersible foam 215. Uncured durable water-dispersible foam spray 235 may be sprayed onto saguaro 220 from a dispensing apparatus that may comprise nozzle 240 that may be connected to storage container 250. After durable water-dispersible foam 215 has cured, saguaro 220 may be dug up, transported by forklift or truck, replanted, and then hosed down to remove durable water-dispersible foam 215. During transportation, roots 225 may be left exposed to air to permit saguaro 220 to respirate, or roots 225 may also be encapsulated to protect them. Line 230 denotes ground level. Encapsulation with durable water-dispersible foam 215 may prevent significant damage to saguaro 220 and also protects transplanting crewperson 245 from the sharp cactus spines. For particularly large or delicate plants, a wood or metal support structure 210 may be built around plant 220 and encapsulated in durable water-dispersible foam 215 with plant 220 to provide additional structural support during transplanting. Handles or attachment points 205 may also be incorporated into the support structure 210 to form a handling structure. For shipment in a horizontal position, only the side in contact with support surfaces need be coated.

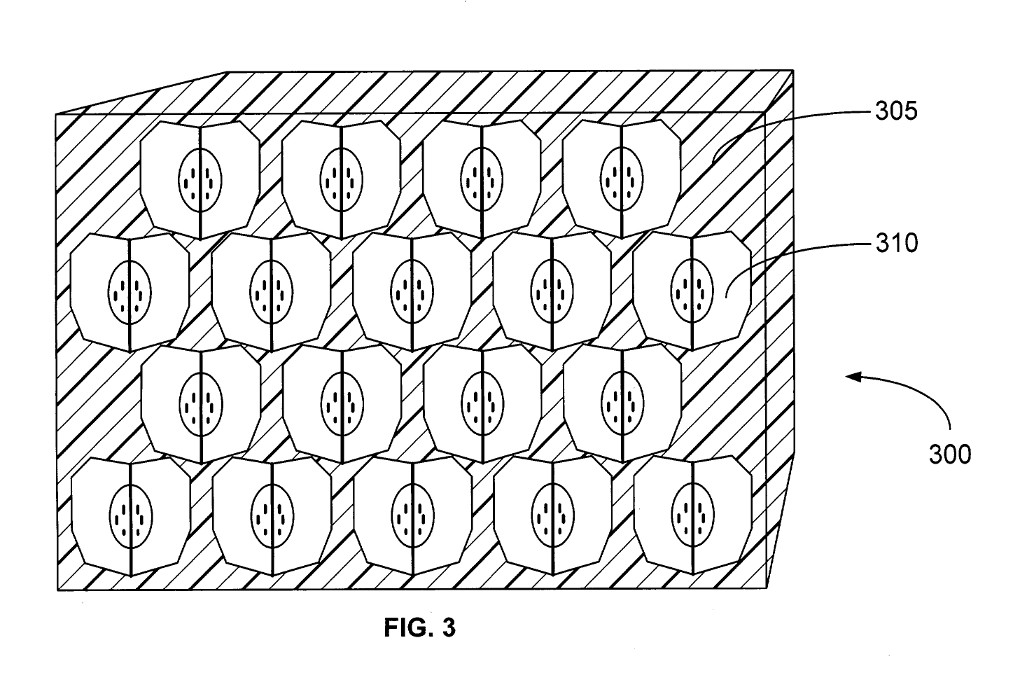

FIG. 3 illustrates a further embodiment of this invention, which comprises encapsulating fruits and vegetables in durable water-dispersible foam for shipment. A bushel box of apples 310, for example, which has been filled with durable water-dispersible foam 305, may arrive at its destination with little or no mechanical damage to any of apples 310. The block 300 of durable water-dispersible foam containing apples 310 may even be removed from its box or mold after durable water-dispersible foam 305 has cured, and may uniquely be shipped without any box at all. Alternatively, a box may be formed of durable water-dispersible foam, and then be filled with apples and additional durable water-dispersible foam. To protect block 300 from premature dissolution, block 300 may be sealed in plastic wrap or sprayed with a water-impervious coating, which may be removed or compromised at the shipping destination, such as a grocery store. After the apples arrive at the grocery store, brick 300 is simply hosed down to release apples 310. Using nitrogen as the blowing gas may prevent oxygen from reaching apples 310 and may preserve them during shipment. Durable water-dispersible foam is uniquely capable of this novel use.

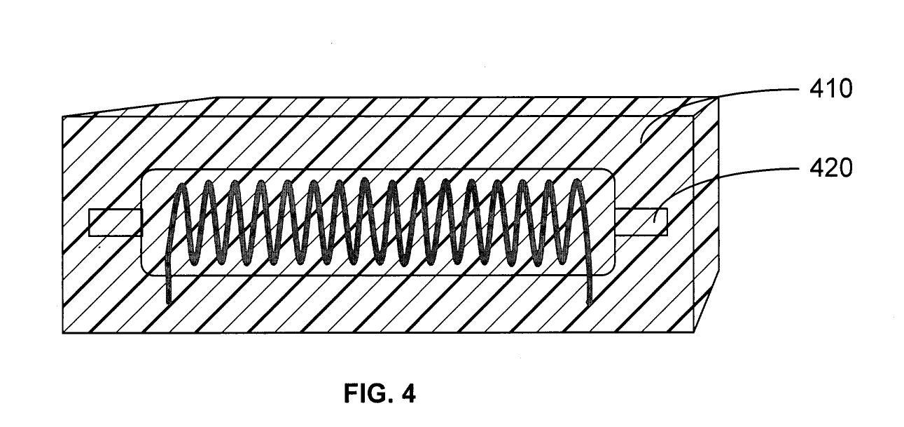

FIG. 4 illustrates an additional embodiment of this invention, which is to use durable water-dispersible foam to protect water-resistant articles from impacts and temperature changes during shipment or handling. For example, a delicate blown-glass object may be completely encased in durable water-dispersible foam for safe and light-weight shipment. Durable water-dispersible foam may have a novel ability to flow into every internal nook and cranny of a delicate object to provide complete structural support, and still be easy to wash away. Other examples of objects that may benefit from being shipped in durable water-dispersible foam include plate glass, stained glass, scientific glassware, fine china, medical appliances, metal objects, plastic objects, stone objects, and water-impervious wooden objects. Surprisingly, a complex, delicate object such as glass distilling tube 420 may be filled with and encased in durable water-dispersible foam 410. When distilling tube 420 arrives at its destination, durable water-dispersible foam 410 is simply washed out of distilling tube 420. As the modulus of elasticity of durable water-dispersible foam 410 may be adjusted with additives, a suitably rigid or elastic durable water-dispersible foam may be designed to best protect any cargo.

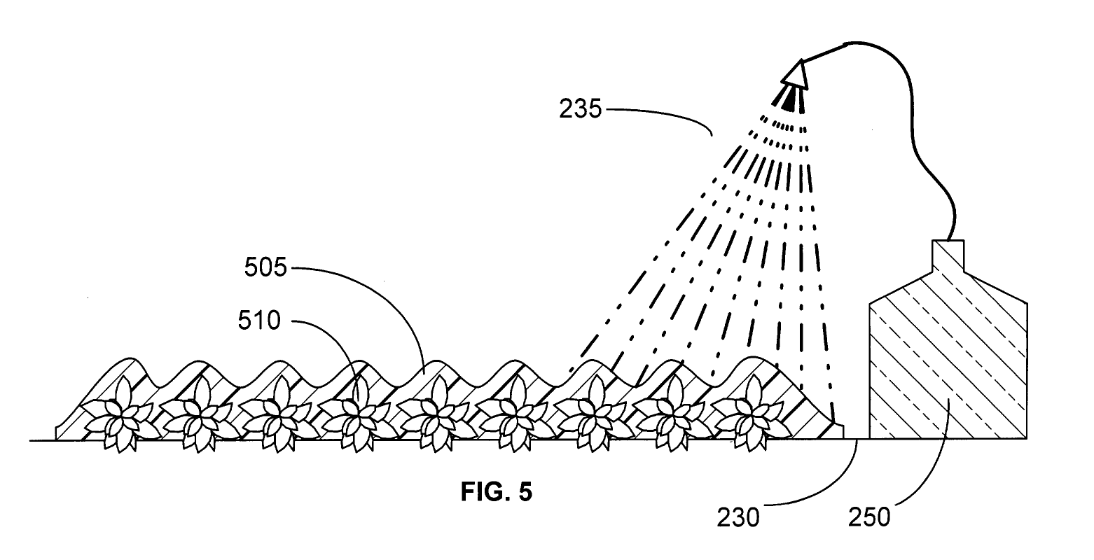

FIG. 5 illustrates a further alternate embodiment of this invention, which is as a spray-on insulation for crops to protect them from freezing. A suitable, low-density durable water-dispersible foam 505 may be applied to crops 510 when a freeze is expected to insulate crop 510 against the cold. When the air warms up the next day after the frost, the thawing frost may melt durable water-dispersible foam 505 away without any further intervention. If the frost water is insufficient, irrigation or rain may wash away any remaining durable water-dispersible foam 505. If the freezing weather lasts one or more days, crop 510 may remain protected because novel durable water-dispersible foam 505 may not dissolve until the weather warms up enough to permit liquid water to dissolve durable water-dispersible foam 505. An ideal durable water-dispersible foam for this application may cling effectively to plants, may flow significantly to cover the entire plant before curing, and may be very low density.

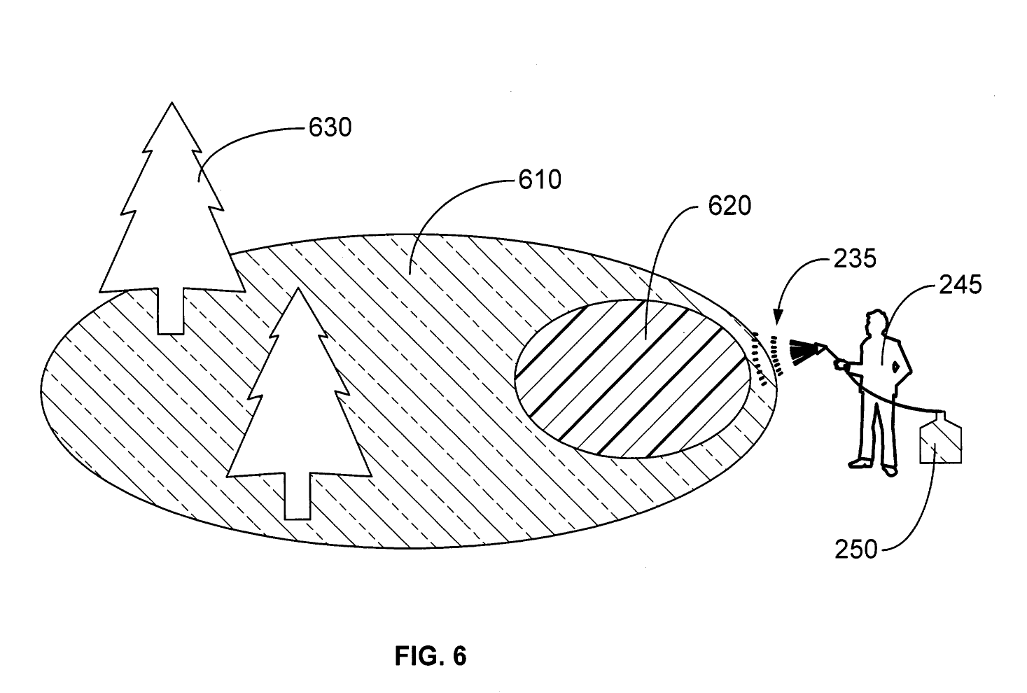

FIG. 6 illustrates a further embodiment of this invention, which comprises using durable water-dispersible foam as a seed-sowing medium. For example, seeds for trees 630 may be mixed into durable water-dispersible foam 620 and sprayed onto an area that needs reseeding, such as a burned-out forest 610. Alternatively, the seeds may be spread on the ground and then covered with durable water-dispersible foam. The seeds may survive safely covered, protected from wind, birds, and insects, and may be released whenever the covered area is irrigated or rained upon. In another example, seeds, fertilizers, and other additives may be contained in pellets of durable water-dispersible foam that may be easily planted and handled. In a further example, ropes of extruded durable water-dispersible foam may have seeds implanted at exact intervals to permit planting perfectly spaced rows.

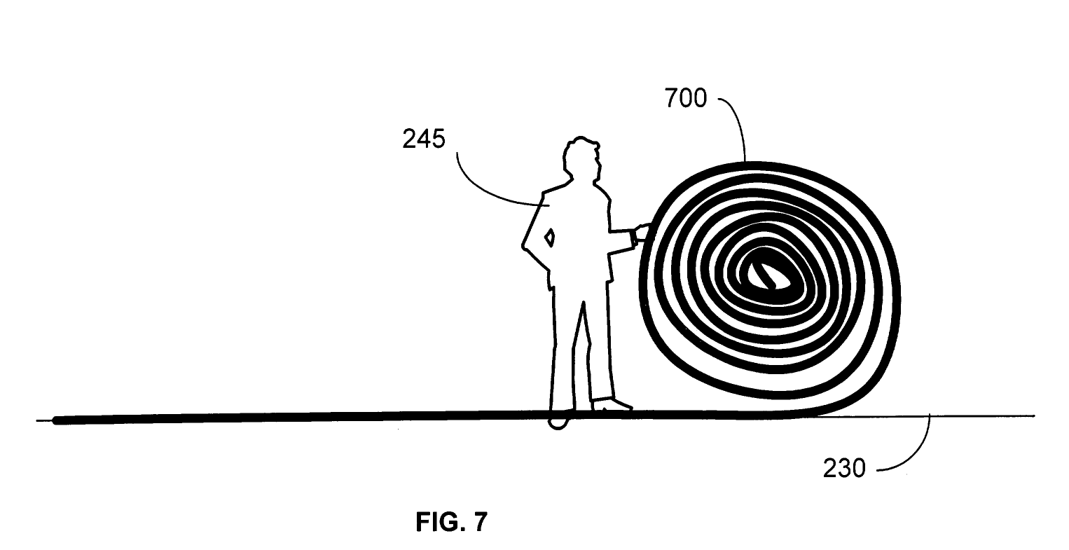

FIG. 7 illustrates a further related embodiment, wherein durable water-dispersible foam may be used on construction sites and other dusty areas to prevent wind erosion. The durable water-dispersible foam may be sprayed or poured on the ground to cover the ground or the ground may be covered in sheets of durable water-dispersible foam 700. Durable water-dispersible foam 700 will keep dust down until rained or irrigated away, and requires no further clean up.

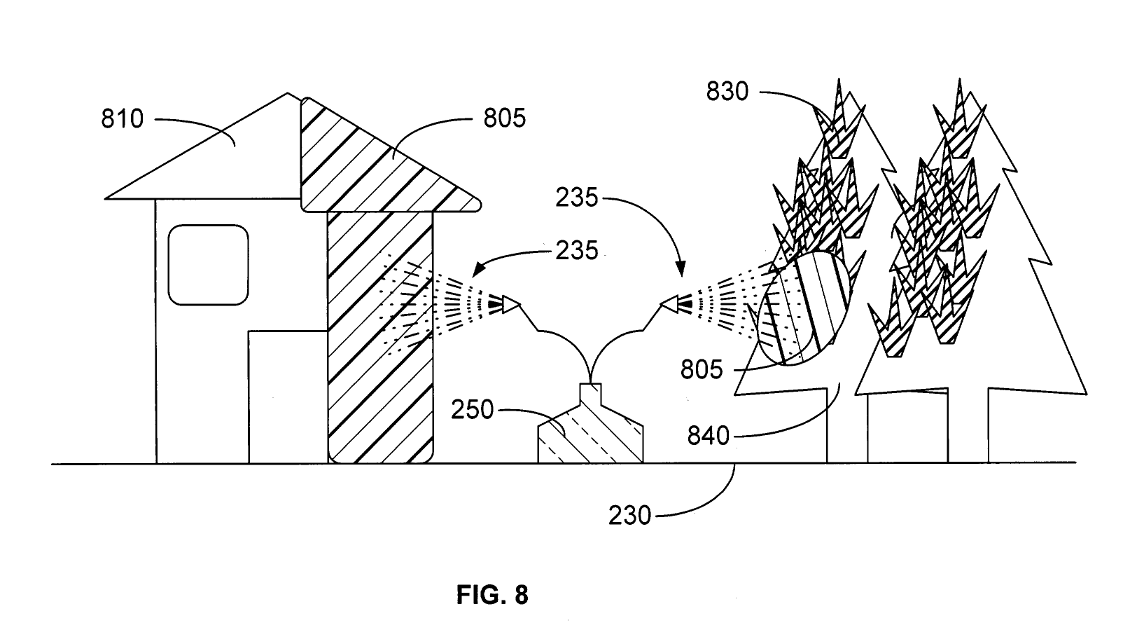

FIG. 8 illustrates a further embodiment of this invention, which is to use durable water-dispersible foam to protect objects from thermal variation by using durable water-dispersible fire fighting foam 805 to extinguish or prevent fires. Durable water-dispersible foam 805, formulated with flame-retardants, mineral fillers, or other suitable additives known in the art of formulating fire-retardant polymer foams, may be sprayed or poured on fire 830 to extinguish it. Also, durable water-dispersible fire fighting foam 805 may be sprayed on ground, trees 840, brush, roofs, and buildings 810 to prevent them from catching fire. In this example, durable water-dispersible fire fighting foam 805 may be used to extinguish fire 830 on trees 840, while protecting house 810 from catching fire. Surprisingly, durable water-dispersible fire fighting foam 805 may remain on house 810 indefinitely, protecting house 810 for days or weeks, until washed or rained away. Durable water-dispersible foams may overcome the limitations of short foam life and difficult clean up which exist in conventional fire fighting foams.

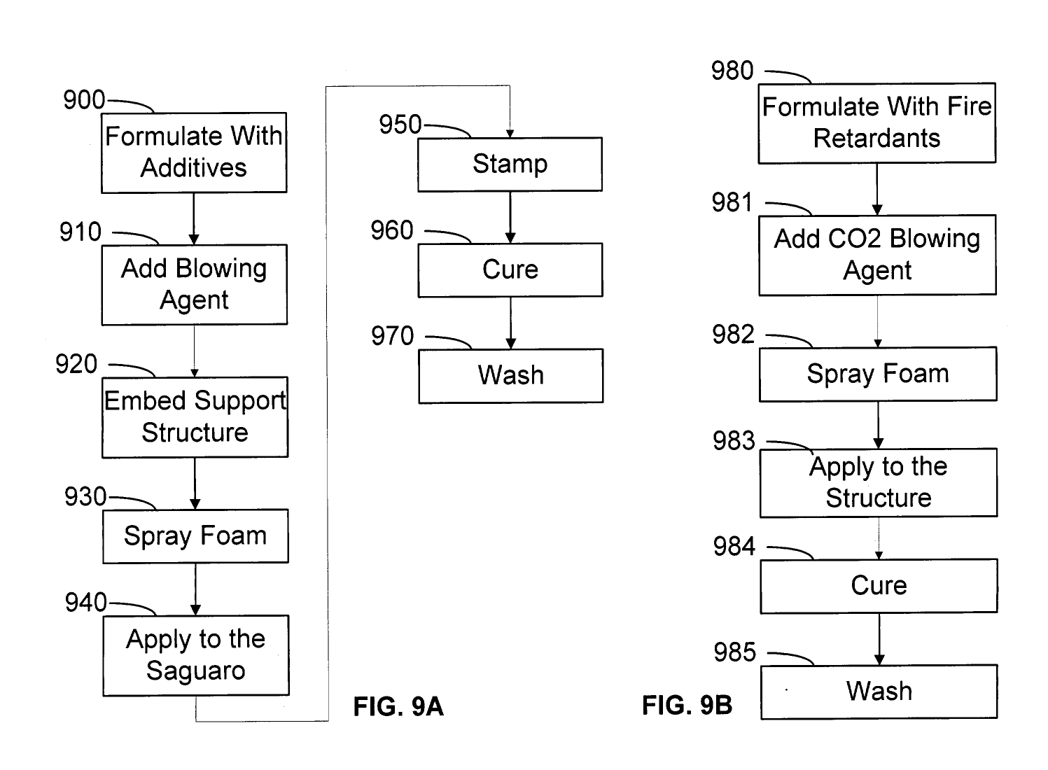

FIG. 9A diagrams the steps of using durable water-dispersible foam to protect a saguaro during transplanting, as was illustrated in FIG. 2. First, the durable water-dispersible foam may be formulated 900 with fertilizers and/or other additives. Air may be added 910 to the formulation as a blowing agent in this example. A support and handling structure 920 may be placed around the saguaro. Durable water-dispersible foam may then be sprayed 930 and applied directly onto 940 the saguaro and the support structure. The soft foam may be shaped by stamping 950 or carving an identifier for the saguaro into the foam. After the durable water-dispersible foam has cured 960, the saguaro may be transplanted. When the transplantation is complete, the durable water-dispersible foam may be washed 970 away.

FIG. 9B diagrams the steps of using durable water-dispersible foam to protect a house from a nearby forest fire, as was illustrated in FIG. 8. First, the durable water-dispersible foam may be formulated 980 with fire retardants, mineral fillers, and/or other additives. Carbon dioxide may be added 981 to the formulation as a blowing agent in this example. The durable water-dispersible foam may then be sprayed 982 and applied directly onto 983 the house which is at risk, covering parts of it. After the durable water-dispersible foam has cured 984, the house may be protected by the durable water-dispersible foam from heat, flying embers, and other sources of flame. When the danger of fire has passed, the durable water-dispersible foam may be washed 985 away.

The following embodiments of the invention comprise using novel durable water-dispersible foam as an advantageous material for conventional applications, so they are not required to be illustrated.

Numerous embodiments of toys are possible with durable water-dispersible foams. For example, cans of spray foam may be used to create sculptures and artworks that dissolve in water, requiring no other clean up. Sand castles and ice sculptures are other examples of temporary art. In another example, a kit comprising plastic monster body parts, a monster body mold, and a can of durable water-dispersible foam may be used to create a monster doll that dissolves when sprayed with water, exposing its body parts. A further example of a durable water-dispersible amusement is durable water-dispersible confetti, ticker tape, or “silly string” aerosol extrusion, which is uniquely easy to wash out of hair and clothing. Durable water-dispersible foam may also be used to build cosmetic appliances for theater and costuming, for example, fake noses, horns, and the like. Such appliances may be modeled directly onto the body or may be made from molds and glued on. Such appliances may be waterproofed as described previously, or antiperspirant may be a useful additive to the foam to protect the foam from perspiration.

Further embodiments in the art of sports equipment are also contemplated. For example, skeet targets, golf tees, and fishing line floats (made from slowly dispersing or coated durable water-dispersible foam) are advantageous uses of durable water-dispersible foam.

An additional embodiment if this invention is the use of durable water-dispersible foam to make disposable plates, bowls, cups, and food cartons. Dense, rigid durable water-dispersible foam would be suggested for this embodiment. The food-touching surface or the entire surface may benefit from an application of water-impermeable lacquer, biodegradable plastic, wax, or other sealant. Durable water-dispersible foam is uniquely able to create rapidly dissolving articles using conventional foam manufacturing equipment.

A further important embodiment of this invention is in the realm of industrial molds and tool making. Durable water-dispersible foam may be used to create molds for casting materials such as rubber, plastics, foods, and possibly metals and ceramics. When the molded object is ready to release from the mold, the durable water-dispersible foam mold may be uniquely washed away in water, instead of being opened. Durable water-dispersible foam may also be useful for creating models of objects, from which molds such as investment casting molds are made; the finished mold may be rinsed out with water, in contrast to melting or burning out waxes as in conventional investment casting techniques. Unique, intricate shapes may be possible with these techniques.

Yet another embodiment of this invention is to use the durable water-dispersible foam to form emergency splints. For example, a broken arm may be encased in durable water-dispersible foam while the patient is taken to the hospital. The splint may be easily removed with water so that the arm may be placed in a permanent cast. In a further example, an accident victim with an injured or broken neck may be partially encased in durable water-dispersible foam to prevent any movement of the injured neck while the victim is transported to the hospital.

Yet another embodiment of this invention is the use of durable water-dispersible foam to seal or mask areas to protect them from non-aqueous contamination. For example, durable water-dispersible foam may be used to mask areas to be sprayed with solvent-based paint. In a further example, durable water-dispersible foam may be used to plug a hole or channel in a metal object that will be dipped in plastic to prevent the hole or channel from being filled with plastic. Durable water-dispersible foam would be uniquely easy to remove after use for these and similar applications.

Durable water-dispersible foam may additionally be suitable for any conventional foam use, if the durable water-dispersible foam can be protected from accidental contact with water.

The following paragraphs describe methods of manufacturing durable water-dispersible foam.

A further embodiment of this invention is a method of manufacture. Durable water-dispersible foams may be manufactured by containing the durable water-dispersible single-component polymer in an aerosol can with any of a solvent, a blowing agent, catalyst, and additives. Durable water-dispersible foams may also be manufactured by containing the multiple components of multiple-component foams in two or more separate containers, adding any of a solvent, a blowing agent, and additives, then combining the components when durable water-dispersible foam is needed. A durable water-dispersible polymer or component is contained when, for example, it is placed in a container that prevents the polymer or components from unintentionally forming durable water-dispersible foam. Conventional methods of and apparatus for storing, packing, and dispensing conventional polymer foams are contemplated for storing, packing, and dispensing novel durable water-dispersible foams.

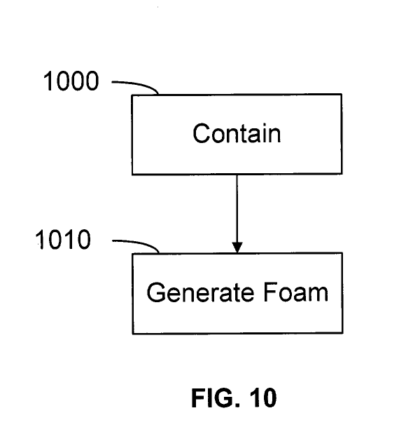

FIG. 10 diagrams the steps of manufacturing durable water-dispersible foam. The ready to use mixtures of polymers, solvents, blowing agents, and/or additives may be contained as shown at 1000 in appropriate containers, prior to being used to generate foam 1010.

The embodiments and examples set forth herein were presented in order to best explain the invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the invention. Accordingly, unless otherwise specified, components of the invention indicated in the drawings or herein are given as an example of possible components and not as a limitation. For example, the use of water-disposable foams to contain hazardous chemical waste spills or to simulate snow is contemplated. Also, the use of durable water-dispersible foams which are transparent to selected electromagnetic wavelengths is contemplated.

I claim:

1. A method of using durable water-dispersible foam, wherein the durable water-dispersible foam comprises:
a polymer foam, which cures at temperatures below the temperature of boiling water, which lasts until dissolved, and which dissolves in aqueous solutions after it has cured;
the method of use comprising the steps of:
dispensing durable water-dispersible foam; and
allowing the durable water-dispersible foam to cure.

2. The method of claim 1, wherein temperatures below the temperature of boiling water further comprise temperatures which do not harm living plants.

3. The method of claim 1, wherein the durable water-dispersible foam further comprises a polymer foam which is biodegradable after being dissolved in aqueous solution.

4. The method of claim 1, wherein the method of use further comprises the step of washing the durable water-dispersible foam away after curing.

5. The method of claim 1, wherein the step of dispensing further comprises the step of at least one of spraying, extruding, pouring, mixing, and injecting.

6. The method of claim 1, further comprising the step of dispensing durable water-dispersible foam onto at least one of a support structure, a handling structure, and an object to be supported or handled.

7. The method of claim 1, wherein the step of dispensing further comprises the step of dispensing durable water-dispersible foam between the inside wall of a container and an object in the container.

8. The method of claim 1, further comprising the step of applying a water-impervious coating to the cured durable water-dispersible foam.

9. The method of claim 1, further comprising the step of containing the durable water-dispersible foam within a water-impervious container.

10. The method of claim 1, wherein the durable water-dispersible foam is used to cover one or more objects, wherein objects comprise at least one of fruits, vegetables, live plants, seeds, glass objects, metal objects, plastic objects, stone objects, the ground, chemicals, and organic substances,
the method further comprising the step of:
applying durable water-dispersible foam to at least a portion of a surface of an object to be covered.

11. The method of claim 1, wherein the durable water-dispersible foam is used to protect one or more objects from impact damage, wherein objects comprise at least one of fruits, vegetables, live plants, seeds, glass objects, metal objects, plastic objects, stone objects, chemicals, and organic substances,
the method further comprising the step of:
applying durable water-dispersible foam to at least a portion of an object or surface to be protected from impact damage.

12. The method of claim 1, wherein the durable water-dispersible foam is used to protect one or more objects from thermal variation, wherein objects comprise at least one of fruits, vegetables, live plants, seeds, glass objects, metal objects, plastic objects, stone objects, chemicals, and organic substances,
the method further comprising the step of:
applying durable water-dispersible foam to at least a portion of a surface of an object to be protected from thermal variation.

13. The method of claim 12, wherein the durable water-dispersible foam comprises a fire-retardant additive and a blowing agent that does not support combustion, further comprising the step of applying the durable water-dispersible foam to at least one of objects which are threatened with fire and objects which are on fire.

14. The method of claim 1, further comprising the step of shaping the durable water-dispersible foam at least one of before, during, and after curing.

15. The method of claim 14, wherein the step of shaping further comprises the step of at least one of sculpting, modeling, carving, molding, extruding, spraying, stamping, cutting, impressing, expressing, compressing, and handling.

16. A method of manufacturing durable water-dispersible foam, wherein the method of manufacture comprises the step of containing durable water-dispersible foam constituents prior to generating durable water-dispersible foam from said constituents.

17. The method of claim 16, wherein the step of containing durable water-dispersible foam constituents comprises the step of containing at least one of prepolymers, polymers, solvents, catalysts, blowing agents, additives, and fillers.

18. The method of claim 16, wherein the step of containing durable water-dispersible foam constituents comprises the step of containing at least one of colorants, minerals, chemicals, desiccants, starches, cellulose, sugars, dyes, flame retardants, foaming agents, foam modifiers, softeners, plasticizers, UV stabilizers, antifungal agents, insecticidal agents, antibacterial agents, seeds, seed-germinating agents, insecticides, antifreeze, fertilizers, nitrogen-fixing bacteria, microorganisms, preservatives, release agents, water-insoluble polymers, antiperspirant, water, and innoculants.

19. The method of claim 16, wherein the step of containing durable water-dispersible foam constituents comprises the step of containing at least one of hydrocarbons, compressed gasses, carbon dioxide, nitrogen, water, and air as a blowing agent for the durable water-dispersible foam.

20. An apparatus for dispensing durable water-dispersible foam, the apparatus comprising a dispenser containing durable water-dispersible foam constituents, wherein the dispenser is operable to dispense durable water-dispersible foam.

21. The apparatus of claim 20, wherein durable water-dispersible foam constituents comprise at least one of prepolymers, polymers, solvents, catalysts, blowing agents, additives and fillers.

22. The apparatus of claim 20, wherein durable water-dispersible foam constituents comprise at least one of colorants, minerals, chemicals, desiccants, starches, cellulose, sugars, dyes, flame retardants, foaming agents, foam modifiers, softeners, plasticizers, UV stabilizers, antifungal agents, insecticidal agents, antibacterial agents, seeds, seed-germinating agents, insecticides, antifreeze, fertilizers, nitrogen-fixing bacteria, microorganisms, preservatives, release agents, water-insoluble polymers, and innoculants.

23. The method of claim 20, wherein durable water-dispersible foam constituents comprise at least one of hydrocarbons, compressed gasses, carbon dioxide, nitrogen, water, and air as a blowing agent for the durable water-dispersible foam.

24. A composition of matter comprising:
a polymer foam, which cures at temperatures below the temperature of boiling water, which lasts until dissolved, and which dissolves in aqueous solutions after it has cured.

25. The composition of matter of claim 24, further comprising a foam with Indentation Force Deflection values between approximately 1 and 100 pounds/square inch, when tested according to ASTM D3574.

26. The composition of matter of claim 24, further comprising a hydrocarbon polymer foam.

27. The composition of matter of claim 24, further comprising at least one of a thermoplastic and thermosetting polymer foam.

28. The composition of matter of claim 24, further comprising at least one of a polyurethane, polyethylene, polypropylene, polyether, acrylic, rubber, epoxy, and polyvinyl alcohol foam.

29. The composition of matter of claim 24, further comprising a foam blown with at least one of hydrocarbons, compressed gasses, carbon dioxide, nitrogen, water, and air.
